(19) United States
(12) Patent Application Publication
(10) Pub. No.: US 2006/0198499 A1
(43) Pub. Date: Sep. 7, 2006

(54) Device and method for adapting the recording parameters of a radiograph

(76) Inventors: Lothar Spies, Aachen (DE); Henrik Botterweck, Aachen (DE); Jürgen Weese, Aachen (DE)

Correspondence Address: PHILIPS INTELLECTUAL PROPERTY & STANDARDS, 595 MINER ROAD, CLEVELAND, OH, 44143, US

(21) Appl. No.: 10/548,983

(22) PCT Filed: Feb. 27, 2004
(86) PCT No.: PCT/IB04/00527

§ 371 Date: Sep. 7, 2005

(30) Foreign Application Priority Data
Mar. 10, 2003 (EP) 03100589.5

(51) Int. Cl. G01D 18/00

(52) U.S. Cl. 378/207

(57) ABSTRACT

The invention relates to a method of adapting imaging parameters for a computer tomographic radiograph of a body volume, comprising the following steps: obtaining a three-dimensional pilot radiograph with a low dose of radiation (1); determining a region of interest and a desired image quality in the pilot radiograph (2) with the aid of a patient model (4) or interactively (3); determining optimal imaging parameters (5); generating an X-ray image using the determined imaging parameters (6). Optionally, the X-ray image is combined (7) with the pilot radiograph.

The invention relates to a method of adapting the imaging parameters of a medical radiograph of a body volume and also to a control device and X-ray apparatus designed to carry out the method.

U.S. Pat. No. 6,195,409 B1 discloses a method of adapting the imaging location of a computer-tomographic radiograph, in which firstly a pilot image is taken of a patient's body volume that is to be imaged. Structure information is then derived from the pilot image in order to obtain a model of the imaging area which is then adapted to a stored patient model. The positions of imaging regions of interest that are known in the patient model, for example the profile of the spinal column, can thus be transferred onto the model. From this, it is possible to determine the geometric settings of the X-ray apparatus, which image the selected region of interest of the actual body. An adaptation of parameters that affect image quality is not described.

Typically, when generating radiographs using for example a computer-aided tomography scanner, predefined protocols are used which prescribe a set of parameters (current of the X-ray tube, voltage of the X-ray tube, etc.) for each part of the body and the nature of the disorder that is to be investigated. These standard settings may accordingly be adapted in particular cases in accordance with the knowledge of the user, for example in the case of very large patients or in the case of small children. In the past, many improvements to X-ray technology have been developed, for example a reduction of the dose by means of adaptive filtering (WO 02/11068 A1), by modulating the current of the X-ray tube (EP 1 172 069 A1), by repeated scans at different aperture settings and the like. These developments comprise a previously unknown flexibility in the definition of the imaging protocol and in particular in the optimization of the image quality for a region of interest. Nevertheless, the integration of this method into standard protocols is difficult on account of the large number of degrees of freedom. In particular, the high level of flexibility makes it practically impossible for the user of a CT system to define a imaging protocol which delivers the desired image quality at a minimum dose of radiation.

Against this background, it is an object of the present invention to provide means for adapting the imaging parameters of a medical radiograph of a body volume, in which a desired image quality can be achieved in a region of interest with minimum exposure to radiation.

This object is achieved by a method having the features of claim 1, by a control device having the features of claim 10, and by an X-ray apparatus having the features of claim 16. Advantageous refinements are given in the dependent claims.

The method according to the invention is used to adapt the imaging parameters of a medical radiograph of a body volume, where the imaging may in particular be a computer-tomographic two-dimensional or three-dimensional imaging. The method comprises the following steps:

a) The obtaining of a “model” or representation of the body volume in question. The model is typically described by a two-dimensional or three-dimensional data record.

b) The determination of a region of interest on the basis of the abovementioned model or within the model. This determination may take place for example interactively by the user of the X-ray apparatus or automatically.

c) The determination of imaging parameters for the region of interest, which are optimal with respect to a predefined criterion. The model from step a) is preferably used to define the imaging parameters.

d) The generation of an X-ray image of the region of interest of the body volume, based on the determined optimal imaging parameters.

The method described has the advantage that by using a model of the body volume it is possible to locate a region of interest and determine a set of optimal imaging parameters tailored thereto. The parameters are therefore defined specifically for the individual case, but their determination requires that the examined patient be exposed to radiation only to a minimum extent.

The imaging parameters which can be adapted by means of the method may include in particular the applied dose of radiation, the voltage of the X-ray tube, the current of the X-ray tube, the aperture setting of the X-ray apparatus, the filter setting of the X-ray apparatus, the imaging duration and/or the imaging area. In particular, the imaging parameters can define not only the geometry of the X-ray image generated but also those variables that affect image quality.

The obtaining of a model of the body volume according to step a) may take place in various ways. According to a first embodiment, the model of the body volume is obtained from a “pilot” radiograph with a low dose of radiation. Preferably, the pilot radiograph gives a three-dimensional representation of the recorded body volume. By means of the pilot radiograph, a model that coincides exactly with the individual anatomy can be generated while exposing the patient to a minimum dose of radiation, and this model is then available for defining a region of interest and optimal imaging parameters.

The abovementioned pilot radiograph is preferably used to generate the X-ray image in step d) of the method, so that the information contained therein and obtained under exposure to radiation—albeit a low dose—is not lost.

According to another embodiment of step a), the model of the body volume is obtained from stored previous radiographs of the body volume. In many cases, previous radiographs will already have been taken of a patient that is to be examined, and these can be called up from an archive. By using these existing data, a model which is matched individually to the patient can be obtained without extra exposure to radiation.

Furthermore, a standardized patient model may also be used for step a) of the method. Said standardized patient model may consist for example of stored radiographs of a reference patient or be a mathematical model defined in abstract terms. The patient model also has the advantage that it can be obtained without the patient under examination having to be exposed to radiation.

The above-described embodiments for obtaining the model by means of stored patient radiographs or a mathematical patient model are optionally adapted to at least one current radiograph of the body volume. Such a two-dimensional or three-dimensional radiograph is preferably obtained with the patient being exposed to a very low dose of radiation and is used to adapt the aforementioned models individually to the present situation.

According to a preferred embodiment of the method, the X-ray image of the body volume that is generated in step d) is reconstructed from X-ray projection images that have been taken from various directions. The optimal imaging parameters defined in step c) in this case preferably include values for a minimum aperture opening of the X-ray apparatus, which is defined such that the region of interest is detected along with a border area of predefined width around the region in all projection images. The border area around the region of interest is necessary to ensure a sufficient imaging quality within the region of interest. It is typically only a few millimeters. The aperture setting on the one hand ensures a complete and qualitatively good imaging of the region of interest and on the other hand, on account of the minimality, ensures that the radiation to which the patient is exposed is limited to a minimum dose.

Another embodiment of the invention is likewise based on the fact that the X-ray image is reconstructed from X-ray projection images from various directions. In this case, the current of the X-ray tube (as an optimal parameter defined in step c) is modulated as a function of the projection direction of the X-ray projection images such that an image quality measure based on the region of interest is observed in the projection images. Such a modulation of the current of the X-ray tube may contribute to further minimizing the amount of radiation to which the patient is exposed since the radiation dose is always set, as a function of the direction, only to the level required to ensure the desired image quality.

Preferably, maximum doses of X-ray radiation that have to be observed are also taken into account in the determination of optimal imaging parameters in step c) of the method. Such maximum doses may be prescribed for example in the case of certain disorders or for specific organs and have a higher priority than a desired imaging quality.

The invention furthermore relates to a control device for an X-ray apparatus for generating X-ray images of a body volume, where the control device comprises the following components:

a model unit for obtaining a model of the body volume;

a definition unit for determining a region of interest on the basis of a model provided by the model unit;

a parameter determination unit for determining optimal imaging parameters for the region of interest determined by the definition unit.

The control device may be formed for example by a data processing unit (computer, microprocessor) having data and program memories. It can be used to carry out the abovementioned method so that the advantages thereof can be obtained. The control device is preferably designed such that it can also carry out the abovementioned variants of the method.

In particular, the control device may include a user interface (keyboard, mouse, monitor, disk, etc.) via which a user can provide the control device with data or receive data from the control device. The user interface is preferably designed such that it permits interaction with the definition unit so that a user can interactively define a region of interest.

Furthermore, the control device may include an interface for the connection of an X-ray radiation source and/or an X-ray detector. Via this interface the control device can then receive data from the aforementioned devices (particularly raw imaging data from the X-ray detector) and transmit information and control commands to said devices.

The control device may furthermore comprise an image processing unit coupled to the model unit, for processing (raw) X-ray data to form an X-ray image. By virtue of the coupling to the model unit, it is possible to also take into account, in the processing, information from the model unit, such as a pilot radiograph for example.

The imaging parameters defined by the parameter determination unit may be, in particular, the applied dose of radiation, the voltage of the X-ray tube, the current of the X-ray tube, the aperture setting, the filter setting, the imaging duration and/or the imaging area.

The model unit of the control device is optionally designed to obtain the model of the body volume from a preferably three-dimensional pilot radiograph with a low dose of radiation.

The invention furthermore relates to an X-ray apparatus for generating X-ray images, which comprises the following components:

an X-ray radiation source for generating a bundle of X-rays;

an X-ray detector for the locally resolved measurement of the X-ray radiation after passing through the body of a patient;

a data processing unit connected to the X-ray radiation source and the X-ray detector, for controlling the image generation and for processing the radiographs obtained.

The data processing is designed to carry out the following steps:

obtaining a model of the body volume;

determining a region of interest on the basis of the model;

determining optimal imaging parameters for the region of interest;

generating an X-ray image of the region of interest of the body volume based on the optimal imaging parameters.

The X-ray apparatus can be used to carry out the abovementioned method so that the advantages thereof are obtained. The X-ray apparatus or the data processing unit thereof is preferably designed such that it can also carry out the abovementioned variants of the method.

The invention will be further described with reference to examples of embodiments shown in the drawings to which, however, the invention is not restricted.

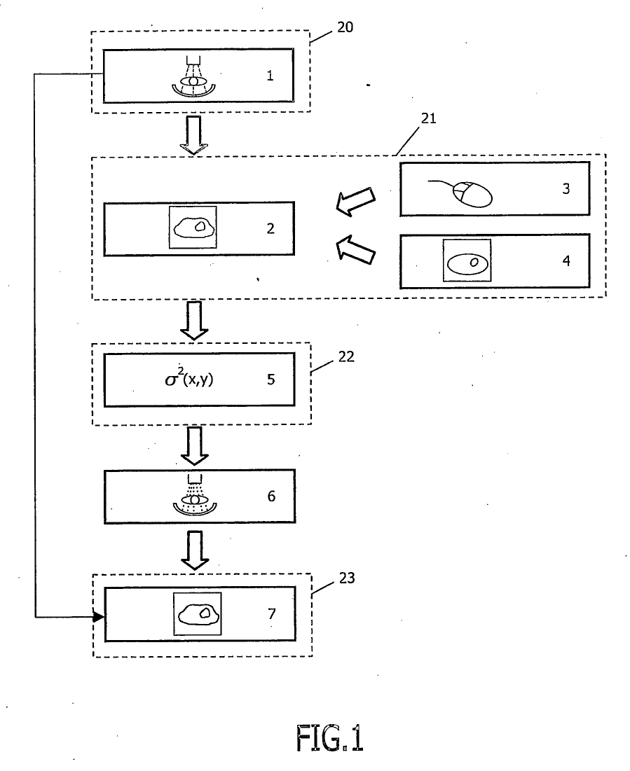

FIG. 1 is a flowchart of the method according to the invention for adapting imaging parameters.

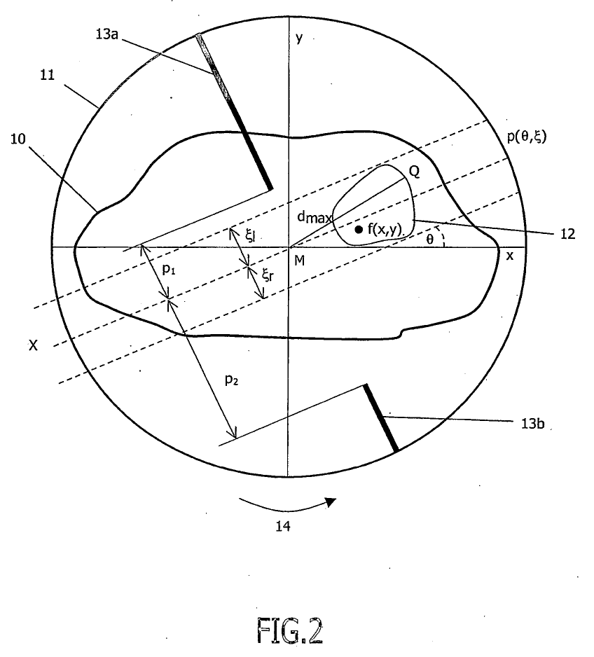

FIG. 2 is a schematic section through a body volume with a region of interest and the relevant variables for calculating an aperture setting.

FIG. 1 shows the successive steps of a method according to the invention for optimizing the imaging protocol of an X-ray image. Hereinbelow, the case of computer-aided tomography will be considered by way of example, although the method is not restricted thereto. Furthermore, FIG. 1 shows in dashed lines the components of a control device in which the corresponding method steps can be carried out. The control device may in this case be in particular a data processing unit with associated data and program memories. The various components of the control device are in this case formed by various modules of a program running on the data processing unit.

In the first step 1 or in a model unit 20 a three-dimensional pilot radiograph is recorded or reconstructed with a low dose of radiation in order to obtain a model of the body volume that is to be examined.

In the next step 2 a diagnostically relevant region of interest (cf. reference 12 in FIG. 2) is defined from this pilot radiograph. Furthermore, a desired image quality is defined for this region of interest, and this may be effected for example by specifying the maximum noise. The region of interest and the image quality may be defined interactively by the operator of the X-ray apparatus (step 3). Alternatively, they can also be defined, according to step 4, with the aid of a predefined, stored patient model comprising application-specific predefined regions and image quality parameters, where the patient model is adapted to the pilot radiograph for example by means of elastic registering (cf. P. Rösch et al., “Robust 3D deformation field estimation by template propagation”, Proc. of MICCAI 2000, LNCS 1935). Steps 2, 3 and 4 are carried out in a definition unit 21 of the control device.

Using the information determined, the imaging parameters contained in a reference protocol are optimized (see below) in step 5 or in a parameter determination unit 22, in order to reduce the radiation dose while at the same time ensuring the desired image quality. The optimal imaging parameters determined in this way are then used as a basis in the generation of the actual X-ray image in step 6.

In step 7 or in an image processing unit 23, the resulting data of the X-ray image from step 6 are optionally combined with the data obtained with a low dose of radiation in step 1, and the final X-ray image is reconstructed.

Besides the optimization of the image quality in a defined region of interest, it may also be important to reduce or limit the dose for specific organs during the obtaining of the image. This information may be taken into account in step 2 of FIG. 1. The subsequent adaptation and optimization of the imaging protocol is then directed at a compromise between image quality and dose reduction for specific organs or at a maximum achievable image quality in the region of interest while at the same time satisfying dose limitations in all regions.

The model can also be obtained in step 1 by using previously obtained tomographic patient images from an archive or by using tomographic data from a reference patient. In these two cases, data defined interactively on the models, such as a region of interest for example, must be adapted to the patient during the diagnosis. This may be effected for example by one or two pilot images being generated at different angles, said pilot images being adapted two-dimensionally or three-dimensionally to the previous patient data (first case) or to the reference data (second case) (cf. G. P. Penney, J. A. Little, J. Weese, D. L. G. Hill, D. J. Hawkes, “Deforming a preoperative volume to represent the intraoperative scene”, Comput. Aided Surg. 2002, 7(2), 63; G. P. Penney, J. Weese, J. A. Little, P. Desmedt, D. L. G. Hill, D. J. Hawkes, “A comparison of similarity measures for use in 2D-3D medical image registration”, IEEE Trans. Med. Imag. 1998, 17(4), 586).

An important step in the abovementioned method is the determination of optimized imaging parameters in step 5. By way of example, one of many possible embodiments of this optimization step 5 will be described below in more detail.

FIG. 2 in this respect shows the circular field of view 11 of a CT scanner rotating in the direction of the arrow 14, said CT scanner containing the body 10 of a patient. Within the body 10 there is a region of interest 12 shown in gray, and this region of interest is to be examined and (exclusively) imaged in detail. In order to simplify the description, FIG. 2 refers to a geometry having parallel X-rays and to the obtaining of a single sectional image. The X-ray radiation X passes through the body volume 10 at an angle θ relative to the horizontal. In one complete X-ray scan, a series of such projection images are generated over an interval of 180° of the projection angle θ. The individual projection images are described by the projection function p(θ,ξ), where ξ is the distance measured with respect to a ray running through the center point M of the field of view 11 (at the same time center of rotation of the CT scan). The aim of a computer-tomographic imaging is to reconstruct, from the projection images p of all projection directions θ, the image points f(x,y) of the imaged region, where x and y are coordinates with respect to the center point M of the field of view. The equations (cf. EP 1 172 069 A1)
f(x,y)=∫dθ dξ p(θ,ξ)k(x cos θ+y sin θ−ξ)
σ²(x,y)∝∫dθdξI⁻¹(θ,ξ)e^{p(θ,ξ)} k²(x cos+y sin θ−ξ)
may be used to derive a specific strategy for determining optimal imaging parameters for step 5 of the method of FIG. 1. The variable σ²(x, y) is in this case the noise of the reconstructed image f (x,y) in the case of a filtered back-projection with the filter core k(ξ). The variable I(θ,ξ) describes the current of the X-ray tube during the imaging of the image, where the dependence on the projection angle θ detects any modulation of the current of the X-ray tube to minimize the radiation dose. The (virtual) dependence of the X-ray tube current I on the coordinate ξ takes into account the effect of apertures 13a, 13b or filters and the resulting variation in the radiation intensity within a projection image p(θ,ξ) in a given projection direction θ.

Since the filter core k(ξ) decreases rapidly as the value 141 of its argument increases, the intensity of X-rays more than a defined distance r away from the region of interest 12 can be considerably reduced without thereby notably increasing the noise in the region of interest 12. Against this background, it is possible to define the position of two semi-transparent apertures 13a, 13b as a function of the region of interest 12, as described below.

FIG. 2 shows, for a given projection angle θ, two X-rays having the coordinates ξₗ(θ) and ξᵣ(θ), which make contact with the region of interest 12 on its left and right side, respectively. The greater of the two absolute values of said coordinates assumes a minimum value ξₘᵢₙ at a defined projection angle θₘᵢₙ:
ξₘᵢₙ=min/θmax{|ξ₁(θ)|, |ξᵣ(θ)|}=max{|ξ₁(θₘᵢₙ)|, |ξᵣ(θₘᵢₙ)|}
Furthermore, the maximum distance dₘₐₓ from the center of rotation M of the CT scan which a point Q of the region of interest 12 may have is determined.

Using the two variables ξₘᵢₙ and dₘₐₓ and also the distance r for which the amount of X-ray radiation in the reconstructed image is approximately negligible, the positions of the two apertures 13a, 13b are determined as follows:
p₁=ξₘᵢₙ+r, p₂=dₘₐₓ+r

Using these aperture positions p₁ and p₂, projections from the angular range [θₘᵢₙ, θₘᵢₙ+180°] are obtained by switching the current of the X-ray tube on during the rotation of the X-ray tube in the direction of the arrow 14 at the angular position θₘᵢₙ and switching it off again when the position θₘᵢₙ+180° is reached.

Sectional artefacts within the reconstructed image, which are represented by singularities in the quality σ² of the image, may be avoided by using the pilot image obtained at a low dose in step 1 of FIG. 1, which was used to plan and optimize the imaging protocol, to complete the data obtained.

The method described provides a means of optimizing a imaging protocol which allows the adaptation of a protocol to an individual patient, a local definition of image quality parameters and a local limitation of the radiation dose used during a CT imaging. Firstly, pilot images or 3D images are obtained while exposing the patient to a low dose of radiation. Within these images, the diagnostically relevant regions and the desired image quality are defined. Using this information, the imaging parameters of a reference protocol, such as the aperture settings and the modulation of the current of the X-ray tube for example, can then be optimized, in order to reduce the dose while ensuring the image quality. The resulting imaging protocol is finally used for image generation and reconstruction purposes. The pilot imaging at a low dose of radiation generated in the first step can be used in the reconstruction of the final image. It is advantageous in the method that the image parameters and the dose can be optimized for this purpose both in the projection plane and perpendicularly since a three-dimensional model is used. In this way, it is possible to take sufficient account for example of structures which require a dose reduction (for example the eyes in the case of head scans).

1. A method of adapting the imaging parameters of a medical radiograph of a body volume, comprising the steps:
a) obtaining a model of the body volume;
b) determining a region of interest on the basis of the model;
c) determining optimal imaging parameters for the region of interest;
d) generating an X-ray image of the region of interest of the body volume based on the optimal imaging parameters.

2. A method as claimed in claim 1, wherein the imaging parameters include the applied dose of radiation, the voltage of the X-ray tube, the current of the X-ray tube, the aperture setting, the filter setting, the imaging duration and/or the imaging area.

3. A method as claimed in claim 1, wherein the model of the body volume is obtained from a three-dimensional pilot radiograph with a low dose of radiation.

4. A method as claimed in claim 3, wherein the pilot radiograph is used in the generation of the X-ray image in step d).

5. A method as claimed in claim 1, wherein the model of the body volume is obtained from stored previous radiographs of the body volume or from a stored patient model.

6. A method as claimed in claim 5, wherein the model of the body volume is adapted to at least one current radiograph.

7. A method as claimed in claim 1, wherein the X-ray image in step d) is reconstructed from projection images from various directions, and in that a minimum aperture opening of the X-ray apparatus is defined such that the region of interest is detected along with a predefined border area in all projection images.

8. A method as claimed in claim 1, wherein the X-ray image is reconstructed from projection images from various directions, and in that the current of the X-ray tube is modulated as a function of the projection direction such that an image quality measure relating to the region of interest is observed.

9. A method as claimed in claim 1, wherein maximum doses of X-ray radiation that must be observed are taken into account when determining optimal imaging parameters in step c).

10. A control device for an X-ray apparatus for generating X-ray images of a body volume, comprising
a model unit for obtaining a model of the body volume;
a definition unit for determining a region of interest on the basis of a model provided by the model unit(;
a parameter determination unit for determining optimal imaging parameters for the region of interest determined by the definition unit.

11. A control device as claimed in claim 10, further including a user interface which permits interaction with the definition unit.

12. A control device as claimed in claim 10, further including an interface for the connection of an X-ray radiation source and/or of an X-ray detector.

13. A control device as claimed in claim 10, further including an image processing unit coupled to the model unit, for processing X-ray data to form an X-ray image.

14. A control device as claimed in claim 10, wherein the imaging parameters include the applied dose of radiation, the voltage of the X-ray tube, the current of the X-ray tube, the aperture setting, the filter setting, the imaging duration and/or the imaging area.

15. A control device as claimed in claim 10, wherein the model unit is designed to obtain the model of the body volume from a three-dimensional pilot radiograph with a low dose of radiation.

16. An X-ray apparatus for generating X-ray images, comprising
an X-ray radiation source;
an X-ray detector;
a data processing unit connected to the X-ray radiation source and the X-ray detector, for controlling the image generation and for processing the radiographs obtained;
wherein the data processing unit is designed to carry out the following steps:
obtaining a model of the body volume;
determining a region of interest Won the basis of the model;
determining optimal imaging parameters for the region of interest;
generating an X-ray image of the region of interest of the body volume based on the optimal imaging parameters.
